(19) United States
(12) Patent Application Publication
(10) Pub. No.: US 2006/0281495 A1
(43) Pub. Date: Dec. 14, 2006

(54) Device and method for sending and receiving voice call contents

(75) Inventor: Sung-Zoon Yang, Icheon (KR)

Correspondence Address: JONATHAN Y. KANG, ESQ.;LEE, HONG , DEGERMAN, KANG & SCHMADEKA, 14th Floor, 801 St. Figueroa Street, Los Angeles, CA, 90017, US

(73) Assignee: LG Electronics Inc.

(21) Appl. No.: 11/450,062

(22) Filed: Jun. 9, 2006

(30) Foreign Application Priority Data
Jun. 10, 2005 (KR) 50017/2005

(51) Int. Cl. H04B 1/38

(52) U.S. Cl. 455/563

(57) ABSTRACT

A mobile communications terminal, and particularly, a device for sending and receiving voice call contents capable of sending and storing the voice call contents, and a method thereof, wherein the device for sending and receiving voice call contents comprises a first mobile communications terminal for converting voice call contents into text information and sending the converted text information; and a second mobile communications terminal for receiving the text information from the first mobile communications terminal and storing the received text information.

### CROSS REFERENCE TO RELATED APPLICATION

Pursuant to 35 U.S.C. § 119(a), this application claims the benefit of earlier filing date and right of priority to Korean Application No. 10-2005-0050017, filed Jun. 10, 2005, the contents of which are hereby incorporated by reference herein in its entirety.

### BACKGROUND OF THE INVENTION

1. Field of the Invention

The present invention relates to a mobile communications terminal, and particularly, to a device and method for sending and receiving voice call contents which is capable of sending and storing voice call contents.

2. Background of the Invention

In general, a voice recognition is executed such that a speaker's voice waveform is analyzed to extract the characteristic of the waveform as an information element and to regard a timely change in the waveform as a pattern, thereby recognizing voice. That is, the voice recognition is executed so that reference patterns of voice related to words which have previously been analyzed and registered can be compared with a pattern obtained by analyzing an unknown input voice, to thusly find the most similar pattern from which the corresponding information element is then extracted.

The related art mobile communications terminal uses the voice recognition to analyze a user's voice and extracts an information element from the analyzed voice to thereafter use the extracted information in a phone number registration.

In the related art mobile communications terminal, a voice recognition apparatus is operated such that a user's voice is received to perform the voice recognition therefor, and a voice-recognized string is compared with a certain string, whereby if the two strings are equal to each other, a number extracted by recognizing the voice is displayed on a screen. However, in the related art voice recognition apparatus, the voice recognition is performed by receiving every voice (audio) signal generated during a call, and accordingly a load is generated in the mobile communications terminal, which causes a performance degradation and unnecessary voice recognition.

Furthermore, every voice is analyzed during the call and information related to the analyzed voice is stored, and thereby unnecessary information may also be stored. As a result, the mobile communications terminal having a limited processing capability may inefficiently use its memory or storage unit for the voice recognition operation.

### SUMMARY OF THE INVENTION

Therefore, an object of the present invention is to provide a device and method for sending and receiving voice call contents which is capable of storing and sending voice information inputted during a call, if necessary.

To achieve these and other advantages and in accordance with the purpose of the present invention, as embodied and broadly described herein, there is provided an device for sending and receiving voice call contents comprising: a first mobile communications terminal for converting voice call contents into text information and sending the converted text information; and a second mobile communications terminal for receiving the text information from the first mobile communications terminal and storing the received text information.

According to another embodiment of the present invention, there is provided a device for sending voice call contents comprising: a keypad having a voice recognition button; and a controller for analyzing voice inputted by activating a voice recognition function by operating the voice recognition button during a call, and for then sending text information corresponding to the analyzed voice to another party's mobile communications terminal.

To achieve these and other advantages and in accordance with the purpose of the present invention, there is provided a method for sending and receiving voice call contents comprising: converting voice inputted during a call into text information and thereafter sending the converted text information to another party's mobile communications terminal; and receiving and storing the text information in the another party's mobile communications terminal.

According to another embodiment of the present invention, there is provided a method for sending and receiving voice call contents comprising: activating a voice recognition function by operating a voice recognition button; and converting voice inputted during a call into text information in the state that the voice recognition function has been activated to thus send the converted text information to another party's mobile communications terminal.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is an exemplary view schematically illustrating a device for sending and receiving voice call contents in accordance with an embodiment of the present invention;

FIG. 2 is a block diagram illustrating a configuration of a device for sending and receiving voice call contents in accordance with an embodiment of the present invention;

FIG. 3 is an exemplary view illustrating a position of a voice recognition button provided on a keypad;

FIG. 4 is an exemplary view implementing a voice recognition button as a soft button;

FIG. 5 is a flowchart illustrating a method for sending and receiving voice call contents in accordance with an embodiment of the present invention; and

FIG. 6 is an exemplary view illustrating a screen conversion by a voice recognition in accordance with an embodiment of the present invention.

### DETAILED DESCRIPTION OF THE INVENTION

Call comments may denote voice call contents transmitted and received between mobile communications terminals during a call.

Description will now be given in detail of the present invention, with reference to the accompanying drawings.

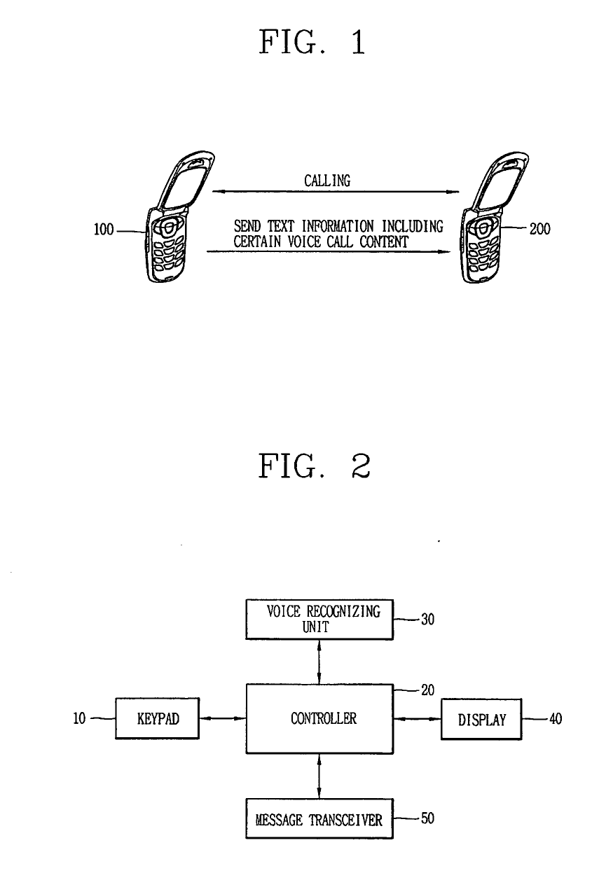

FIG. 1 is an exemplary view schematically illustrating a device for sending and receiving voice call contents in accordance with an embodiment of the present invention.

As illustrated in FIG. 1, first and second mobile communications terminals 100 and 200 are in a call state. Here, a user of the first mobile communications terminal 100 or of the second mobile communications terminal 200 sends certain voice call contents in a format of text information during the call.

For example, when the first mobile communications terminal 100 sends voice call contents to desirably send to the second mobile communications terminal 200 in a format of text information, the first mobile communications terminal 100 sends to the second mobile communications terminal 200 voice call contents in the text information from a voice recognition function being activated to the voice recognition function being deactivated. The text information may preferably be able to be sent by using a short messaging service.

Then, the text information sent from the first mobile communications terminal 100 is received and stored in the second mobile communications terminal 200. Here, the second mobile communications terminal 200 receives text information and displays the received text information, which is similar to an operation for receiving and displaying typical short messages, explanation for which will thusly be omitted.

FIG. 2 is a block diagram illustrating a configuration of a device for sending and receiving voice call contents in accordance with an embodiment of the present invention.

As illustrated in FIG. 2, a keypad 10 is provided with keys for inputting numerals and text information and function buttons for setting various functions. The keypad 10 also has a voice recognition button.

A controller 20 controls an overall operation of the mobile communications terminal. The controller 20 analyzes by use of a voice recognizing unit 30 voice call contents inputted during a call in a state that a voice recognition function has been activated by operating the voice recognition button. The controller 20 then controls an overall operation of the mobile communications terminal to send text information corresponding to the analyzed voice to another party's mobile communications terminal. The controller 20 also controls an operation for composing a message including the text information to then send it to the another party's terminal. In addition, the controller 20 may include the voice recognizing unit 30 and a message transceiver 50.

The voice recognizing unit 30 analyzes voice during a call in a state that the voice recognition function has been activated.

A display 40 displays messages generated while performing a program under control of the controller 20. The display 40 also displays user data according to an operation of the mobile communications terminal. In addition, the display 40 displays screen data according to a process for composing and sending a message including text information by use of the voice recognition function. The display 40 also displays a message including text information received from the another party's terminal. The received message denotes a message including text information corresponding to voice recognized during the call. Here, a Liquid Crystal Display (LCD) may commonly be used as the display 40. In this case, the display 40 may include an LCD controller, a memory for storing image data and an LCD device. Here, when the LCD may be implemented in a touch screen manner, the keypad 10 and the LCD may be used as an input unit.

The message transceiver 50 is used to send the message to the another party's terminal or to receive a message sent by the another party's terminal.

When the voice recognition function is activated by operating a voice recognition button, the mobile communications terminal having such configuration composes a message including text information corresponding to the recognized voice to send it to the another party's terminal.

The mobile communications terminal has the voice recognition button on the keypad 10. When the voice recognition button on the keypad 10 is entered, the voice recognition function is activated. However, upon entering the voice recognition button in a state that the voice recognition function has been activated, the voice recognition function is deactivated. The keypad 10 outputs key data generated by entering the voice recognition button to the controller 20. The conversion of activation/deactivation of the voice recognition function depends on the state of the voice recognition function.

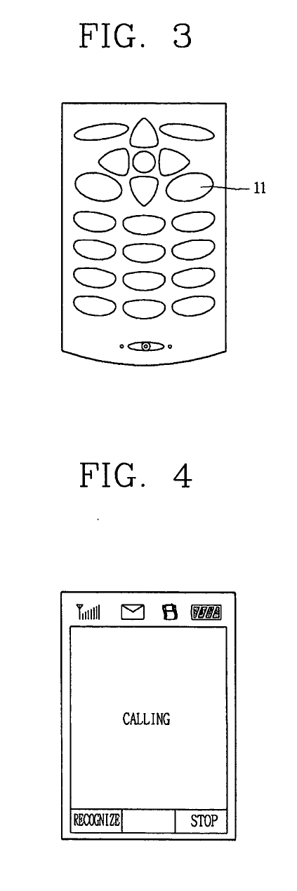

FIG. 3 is an exemplary view illustrating a position of a voice recognition button provided on a keypad.

As illustrated in FIG. 3, a voice recognition button 11 provided on the keypad 10 is allocated to one of function buttons to thus make it convenient to use the voice recognition button 11 during a call. The voice recognition button 11 may be represented by displaying a hot logo on the voice recognition button 11. Also, the voice recognition button 11 may be arranged at a position where it does not interrupt the call to conveniently operate the button during the call.

In stead of arranging the voice recognition button 11 on the keypad 10, a side key may be used as the voice recognition button 11.

In another embodiment, the voice recognition button may not be arranged on the keypad 10 of the mobile communications terminal, but a voice recognition soft button may rather be displayed at a lower end of a call screen to activate/deactivate the voice recognition function by operating the soft button.

FIG. 4 is an exemplary view implementing a voice recognition button as a soft button.

As illustrated in FIG. 1, a mobile communications terminal displays a voice recognition menu at a lower end of a call screen. When the voice recognition menu is selected by operating the soft button, the mobile communications terminal executes the voice recognition during a call. Upon executing the voice recognition, the mobile communications terminal displays the recognition stopping menu at the lower end of the call screen.

It is assumed that a user enters the voice recognition button 11 in a call state with another party, and converts his voice into text information to send a message including the converted text information to the another party.

When it is certified that the user has entered the voice recognition button 11 on the keypad 10 of the mobile communications terminal, a voice recognition request is transferred to the controller 20. The controller 20 then receives the voice recognition request and sends a voice recognition activation signal to the voice recognizing unit 30.

The controller 20 then displays on the display 40 that the voice recognition function has been activated, and displays a voice recognition activation message on a screen. In another embodiment, the controller 20 may output through a speaker a signal (e.g., a sound, a message, etc.) indicating that the voice recognition has been activated to thus inform it to the user.

The voice recognizing unit 30 analyzes a waveform of the user's voice by the voice recognition activation signal and compares the analyzed waveform characteristic with a reference pattern, to thus extract text information. The voice recognizing unit 30 then transfers the extracted text information to the display 40 to display the text information on a screen by the display 40. The user confirms the text information displayed on the screen to be informed of the result of the voice recognition.

Afterwards, it is assumed that the user stops the voice recognition function by entering the voice recognition button 11 and transfers text information to the another party.

When it is certified that the voice recognition button 11 on the keypad 10 has been entered in the activated state that the voice recognition function, a voice recognition stopping request is transferred to the controller 20. The controller 20 receives the voice recognition stopping request and transfers a voice recognition deactivation signal to the voice recognizing unit 30.

When receiving the voice recognition deactivation signal, the voice recognizing unit 30 stores the voice-recognized text information in a storage unit. The controller 20 informs the display 40 and the message transceiver 50 that the voice recognition function has been deactivated. The display 40 displays a voice recognition deactivation message on the screen. The controller 20 outputs a voice recognition deactivation message through the speaker rather than the deactivation message on the screen, to inform the user of the voice recognition stopping.

The message transceiver 50 composes a message including the text information voice-recognized by the voice recognizing unit 30, and sends it to the another party's terminal currently in the call state.

The message transceiver 50 displays the message received from the another party's terminal on the screen to output the voice-recognized text information. The message transceiver 50 certifies a phone number of the another party's terminal currently in the call state, and designates the phone number as a target to which a message is to be sent. The message transceiver 50 then sends the message including the voice-recognized text information.

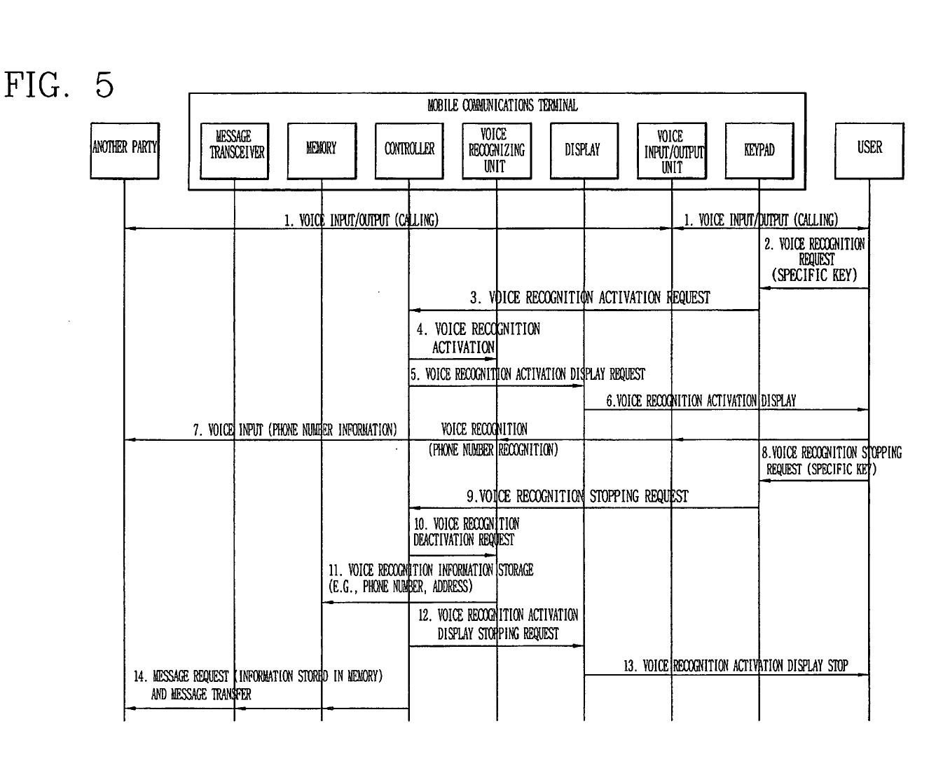

FIG. 5 is a flowchart illustrating a method for sending and receiving voice call contents in accordance with an embodiment of the present invention.

As illustrated in FIG. 5, a method for sending and receiving voice call contents in accordance with an embodiment of the present invention may comprise activating/deactivating a voice recognition function by entering a voice recognition button, executing a voice recognition by receiving a user's voice in an activated state of the voice recognition function, displaying a voice recognition executing message on a call screen upon executing the voice recognition, stopping the voice recognition when it is certified that a voice recognition button has been entered in the activated state of the voice recognition, storing voice-recognized text information in a memory and displaying on a screen that the voice recognition has been deactivated, and composing a message including the voice-recognized text information to send it to another party's terminal currently in a call state.

The method for sending and receiving voice call contents will now be explained in detail. In order to explain in detail the steps, it may be assumed that a user is being communicated with another party and the user uses a voice recognition function when sending his phone number information to the another party.

The mobile communications terminal may regarded as the controller 20 for controlling the overall operation of the mobile communications terminal herebelow.

First, when it is certified that a voice recognition button has been entered during a call in the mobile communications terminal, a voice recognition function is activated. When the voice recognition button is entered in the activated state of the voice recognition function, the voice recognition function is deactivated.

That is, by pressing the voice recognition button, the mobile communications terminal controls the conversion into the activation and deactivation of the voice recognition function, so as to initiate or stop the voice recognition.

In order for the user to enter the voice recognition button while he is calling without stopping the call, the voice recognition button is arranged in a function button to make it convenient to use the voice recognition button during the call. In addition, the voice recognition button may be represented by displaying a hot logo on the voice recognition button, and the user confirms the position of the voice recognition button by the hot logo displayed on the keypad.

In another embodiment, the voice recognition button may not be arranged on the keypad 10 of the mobile communications terminal, but a voice recognition soft button may rather be displayed at a lower end of a call screen to activate/deactivate the voice recognition function by operating the soft button.

When a call connection is successfully performed between a user and another party, the mobile communications terminal displays a voice recognition soft button at a lower end of a call screen, and activates or deactivates the voice recognition function by determining whether the soft button has been inputted.

In still another embodiment, the mobile communications terminal activates the voice recognition function by determining whether the voice recognition button has been entered longer than a certain time, and deactivates the voice recognition function by pressing a voice recognition stopping button. In order to prevent an erroneous input of the voice recognition button during the call, the mobile communications terminal determines whether the voice recognition button has been entered (pressed) longer than a certain time. If it has been pressed longer than the certain time, the mobile communications terminal activates the voice recognition function.

It is assumed that the user enters the voice recognition button while being communicating with the another party and converts his voice into text information to thereafter send a message including the converted text information to the another party. The user activates the voice recognition function by entering the voice recognition button before speaking his phone number to notify it to the another party.

The mobile communications terminal confirms whether the voice recognition button has been entered. If it is confirmed that the voice recognition button has been entered, the mobile communications terminal activates the voice recognition function to execute the voice recognition by receiving the user's voice. Upon executing the voice recognition, the mobile communications terminal displays a voice recognition executing message on the call screen. The mobile communications terminal, in another embodiment, informs the user of the execution of the voice recognition by outputting a signal (or a sound, a message, etc.) indicating the execution of the voice recognition.

The mobile communications terminal displays a time taken by executing the voice recognition from the moment when the voice recognition is initiated, and then displays on the screen the voice-recognized result obtained during the voice recognition being executed. The mobile communications terminal analyzes a waveform of the user's voice, and compares the characteristic of the analyzed waveform with a reference pattern, thereby extracting text information. The mobile communications terminal then displays the extracted text information on a screen. The user confirms the text information displayed on the screen to acknowledge the voice recognition result.

It is then assumed that the user stops the voice recognition by entering the voice recognition button during the voice recognition being executed, and sends the voice-recognized result to the another party.

The mobile communications terminal stops the voice recognition when the voice recognition button is entered in the activated state of the voice recognition function. Here, the mobile communications terminal displays on the screen that the voice recognition function has been deactivated, and stores the voice-recognized text information in the memory. The mobile communications terminal, in another embodiment, outputs a voice recognition deactivation message through a speaker rather than outputting the deactivation message onto the screen, thereby informing the user of the voice recognition stopping.

Afterwards, the mobile communications terminal composes a message including the voice-recognized text information and sends it to the another party's terminal currently in the call state. That is, the mobile communications terminal sends the message including the text information to the phone number of the another party's terminal currently in the call state.

Then, the another party's terminal displays the received message on the screen and outputs the voice-recognized text information.

In stead of sequentially performing deactivating the voice recognition function, storing the voice-recognized text information in the memory, informing the deactivation message to the user, and composing the message including the text information to send it to the another party's terminal, the mobile communications terminal may previously send the message and then deactivate the voice recognition function. For example, the mobile communications terminal previously sends the message including the voice-recognized text information, and then performs the operation of deactivating the voice recognition function.

In another embodiment, when the stopping button is entered while the voice recognition is being executed, the mobile communications terminal composes the message including the voice-recognized text information and sends it to the another party's terminal to thereafter deactivate the voice recognition function. The mobile communications terminal then stores the text information in the storage unit (i.e. the memory) and displays on the screen that the voice recognition function has been deactivated. The mobile communications terminal composes the message including the voice-recognized text information immediately when receiving a request for stopping the voice recognition, and accordingly the mobile communications terminal can fast send the voice recognition result to the another party's terminal.

In still another embodiment, the mobile communications terminal deactivates the voice recognition function by entering the stopping button in the activated state of the voice recognition, stores the voice-recognized text information in the storage unit, composes and sends the message including the text information, and then displays on the screen that the voice recognition function has been deactivated. The mobile communications terminal composes and sends the message including the text information from the initiation of the voice recognition to the stopping thereof, and accordingly can correctly transfer the result of the voice recognition executed for a time duration for which the voice recognition is activated to the another party's terminal.

The mobile communications terminal may execute the voice recognition for the another party's voice rather than the user's voice and store the voice recognition result in the storage unit to thus allow the user to utilize it, embodiment for which will now be explained.

The mobile communications terminal may have a user voice recognition button and a separate another party voice recognition button as soft buttons. When it is confirmed that the another party voice recognition button has been entered, the mobile communications terminal inputs the another party's voice to execute the voice recognition therefor. The mobile communications terminal stops the voice recognition for the another party's voice according to a voice recognition stopping request, and stores the voice recognition result in the memory. The user completes his call and utilizes the voice recognition result stored in the memory to extract useful data included in the voice call content.

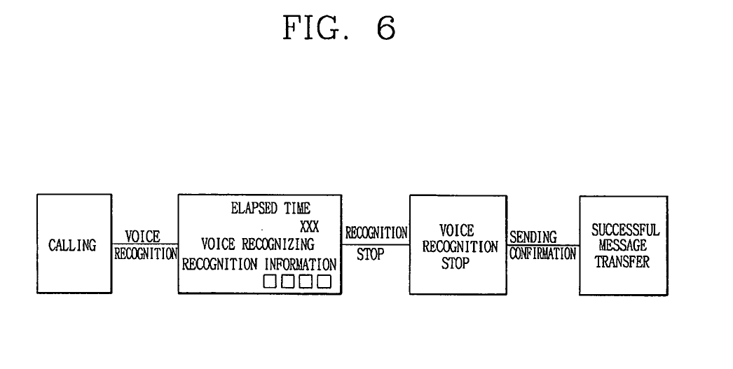

FIG. 6 is an exemplary view illustrating a screen conversion by a voice recognition in accordance with an embodiment of the present invention.

As illustrated in FIG. 6, the voice recognition screen is used to inform the user of the initiation of the voice recognition and to output an elapsed time for the voice recognition being executed and a voice recognition result. An operational state of the voice recognition during the call is displayed on the voice recognition screen to thus display whether the voice recognition is correctly being performed. The voice recognition screen is also used to previously display the voice recognition result to be transferred to the another party so as to prevent an erroneous information sending.

When stopping the voice recognition and sending the voice recognition result to the another party in a massage format, a sent state of the message is displayed on the voice recognition screen to enable a confirmation of whether the message has correctly been sent. Whether the message has correctly been sent is displayed on the voice recognition screen, and accordingly the message may be modified, thereby preparing an incorrect sending of the message, resulting in enabling a determining whether to re-send the message.

When storing the voice recognition result in the storage unit, a file name for the voice recognition result is displayed on the voice recognition screen. Accordingly, the user can refer to the file name to be able to use the voice recognition result.

As described above, in the present invention, the voice recognition for the user's voice is performed, when necessary, during the call, the voice recognition result can be transferred to the another party in the message format. Accordingly, the another party can receive part of the voice call content, and check the message after terminating the call, thereby certifying the voice recognition result. In addition, the voice recognition can be activated by the voice recognition request to thereafter be performed, when necessary, whereby it is efficient to prevent an unnecessary execution of the voice recognition and to improve performance of the terminal by efficiently managing the processing capability of the terminal. Furthermore, although the another party's terminal does not support the voice recognition, the voice recognition result can be sent from the user's terminal to the another party's terminal as the message, and accordingly the another party can receive the voice-recognized voice call content from the user. Also, by storing the typical text information as well as the phone number during the call therebetween, the user can open the stored information after terminating the call to thus reconfirm an important part of the voice call content.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A device for sending and receiving voice call contents comprising:
a first mobile communications terminal for converting voice call contents into text information and sending the text information; and
a second mobile communications terminal for receiving the text information from the first mobile communications terminal and storing the received text information.

2. The device of claim 1, wherein the first mobile communications terminal is configured to store the voice call contents as the text information.

3. A device for sending voice call contents comprising:
a keypad having a voice recognition button; and
a controller for converting voice inputted in a state that a voice recognition function is activated by entering the voice recognition button during a call into text information and sending the converted text information to another party's mobile communications terminal.

4. The device of claim 3, wherein the controller comprises:
a voice recognizing unit for extracting the text information by analyzing user's voice in the activated state of the voice recognition function; and
a message transceiver for composing a message including the extracted text information to send the composed message to the another party's mobile communications terminal which is in the call state, or for receiving a message from the another party's mobile communications terminal.

5. The device of claim 3, wherein the controller controls the sending of the message including the text information corresponding to the voice inputted in the activated state of the voice recognition function during the call.

6. The device of claim 3, wherein the voice recognition button provided on the keypad is allocated to one of function buttons.

7. The device of claim 3, wherein the voice recognition button is one of a side key or a soft key rather than being provided on the keypad.

8. The device of claim 3, wherein the controller is configured to output a notification sound for notifying the activation of the voice recognition function.

9. The device of claim 3, further comprising a display for displaying an operational state of the voice recognition function.

10. The device of claim 9, wherein the display uses icons to display the state that the voice recognition function has been activated and/or deactivated.

11. The device of claim 9, wherein the display displays the voice-recognized text information on a screen.

12. The device of claim 9, wherein the display displays a voice recognition soft button at a lower end of a call screen, and accordingly the soft button is selected to activate and/or deactivate the voice recognition function.

13. The device of claim 3, wherein the controller controls an analyzing of a waveform of the inputted voice and a sending of the text information based upon the analysis to the another party's mobile communications terminal in a message format.

14. The device of claim 3, further comprising a memory for storing the text information based upon the voice analysis.

15. The device of claim 3, wherein the controller controls the analyzing of the voice inputted when the voice recognition function is activated during the call, wherein when the voice recognition function is deactivated, the controller controls the sending of the message including the text information corresponding to the voice inputted in the voice recognition function is activated to the another party's mobile communications terminal.

16. A method for sending and receiving voice call contents comprising:
changing voice inputted during a call into text information and sending the text information to another party's mobile communications terminal; and
receiving and storing the text information in the another party's mobile communications terminal.

17. A method for sending and receiving voice call contents comprising:
activating a voice recognition function by operating a voice recognition button; and
converting voice inputted during a call into text information in the state that the voice recognition function has been activated to thus send the converted text information to another party's mobile communications terminal.

18. The method of claim 17, further comprising:
stopping the voice recognition function when a voice recognition button or a button having the same function as that is selected in the state that the voice recognition function has been activated;
sending the message including the voice-recognized text information to the another party's mobile communications terminal which is in the call state, after stopping the voice recognition function.

19. The method of claim 18, wherein the sending to the another party's mobile communication terminal in the call state comprises:
storing the voice-recognized text information after stopping the voice recognition function; and
composing a message including the stored text information.

20. The method of claim 17, wherein the sending of the text information to the another party's mobile communications terminal comprises:
analyzing voice during a call; and
when text information based upon the analysis is stored and simultaneously the voice recognition function is deactivated, sending a message, which includes the text information corresponding to the voice inputted in the state that the voice recognition function has been activated, to the another party's mobile communications terminal.

21. The method of claim 17, further comprising displaying a voice recognition soft button at a lower end of the call screen in the step of displaying the call screen to thus activate and/or deactivate the voice recognition function by operating the voice recognition soft button.

22. The method of claim 21, further comprising determining whether a soft button corresponding to a user voice recognition button has been inputted or a soft button corresponding to an another party voice recognition button has separately been inputted, and activating and/or deactivating the voice recognition function for the user voice or the another party voice according to the determination.

23. The method of claim 17, wherein the sending of the text information to the another party's mobile communications terminal comprises:
confirming the another party's phone number in the call state, and sending a message including the text information corresponding to the analyzed voice to a mobile communications terminal corresponding to the another party's phone number.

24. The method of claim 17, wherein the sending of the text information to the another party's mobile communications terminal comprises:
storing the text information corresponding to the voice analyzed in the state that the voice recognition function has been activated during the call; and
sending the message including the text information to the another party's mobile communications terminal when the voice recognition function is deactivated by entering a voice recognition deactivation button.

25. The method of claim 17, wherein the sending of the text information to the another party's mobile communications terminal comprises:
converting the voice into the text information in the state that the voice recognition function has been activated and then displaying the converted text information;
requesting a user's confirmation for whether to send the converted text information; and
sending the text information to the another party's mobile communications terminal when it is confirmed that the user desires to send the text information.
